(19) United States
(12) Patent Application Publication
(10) Pub. No.: US 2026/0173179 A1
(43) Pub. Date: Jun. 18, 2026

(54) AUTOMATED DETECTION, PAIRING AND REGULATION OF USER DEVICES ONBOARD VEHICLES

(71) Applicant: Volvo Car Corporation, Gothenburg (SE)

(72) Inventor: Mikael Vassili Räim, Landvetter (SE)

(21) Appl. No.: 18/980,764

(22) Filed: Dec. 13, 2024

(51) Int. Cl. H04W 76/14; G06V 10/774; G06V 20/59; G06V 40/16

(52) U.S. Cl. CPC H04W 76/14; G06V 10/774; G06V 20/593; G06V 40/172

(57) ABSTRACT

Techniques for object identification and accident prevention for vehicles in hazardous (e.g., low visibility) conditions are provided. In an example, a method comprises identifying, by a system onboard a vehicle comprising a processor, one or more passengers inside the vehicle and determining in which seats the one or more passengers are sitting. The method can further comprise identifying, by the system, a device paired to the vehicle, and determining, by the system, an intent of at least one of the passengers. The method can further comprise adjusting, by the system, a parameter of the paired device, based upon the determined intent.

### TECHNICAL FIELD

The disclosed subject matter relates to vehicles (e.g., transportation vehicles), and more particularly, to wireless device detection, identification, pairing and regulation systems for vehicles.

### BACKGROUND

In-vehicle audio systems are continuously evolving to provide improved personalized, private audio experiences for passengers, allowing individuals to receive distinct audio feeds to specific seats. This can be valuable for privacy, such as when a passenger needs to take a phone call and doesn't want others in the vehicle to overhear or to interfere with the call. However, supporting personal wearable devices, like wireless headphones equipped with microphones, remains a challenge in these environments. These devices often require pairing with the vehicle's audio system to enable a seamless and secure audio stream for each passenger. But this pairing process is frequently manual, requiring user intervention, which can lead to inconvenience and inconsistent user experiences.

Typically, when a user wishes to connect their wireless headphones to the vehicle's audio system, they must initiate a pairing process. This process is often the same as with other Bluetooth-enabled devices, where the user must select the vehicle's audio system from a list of available devices. Not only does this take time, but it also disrupts the user experience, especially in shared vehicle environments or when a user frequently changes vehicles. If the user changes seats or if the device is disconnected, they may need to repeat the pairing process each time, creating a frustrating and repetitive experience and compounding user inconvenience. For many, this manual reconnection step is cumbersome, and it detracts from the goal of a seamless in-vehicle audio experience.

Moreover, once paired, current onboard systems fail to account for seat changes among users, or for changes to users, such as when a new user enters or a current user exists a vehicle. For instance, if a passenger paired a device from one seat initially but sits in a different seat during their next use, the system will still associate the device with the original location. This limitation can result in audio misrouting, where audio intended for the user is directed to the wrong location, leading to privacy and usability concerns. With no way to dynamically adjust to the changing seat locations, existing systems fail to deliver on the promise of personalized, seat-specific audio. Current solutions, which rely heavily on manual pairing and basic proximity detection, fall short in addressing the dynamic seating environments within vehicles.

The above-described background relating to user identification and pairing systems for devices onboard vehicles is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products can facilitate automated detection, pairing and regulation of user devices onboard vehicles.

In-vehicle audio systems continue to advance, offering passengers personalized and private audio experiences by routing sound to specific seats. This can be particularly beneficial in ensuring privacy, such as when a passenger wishes to take a private call or listen to media without disturbing others. Such systems can also be valuable in shared or multi-passenger vehicles, where individual privacy needs can vary. However, incorporating personal wearable devices, such as wireless headphones with microphones, presents continuing challenges. These devices, which can rely on Bluetooth or similar wireless technology, typically require pairing with the vehicle's audio system for a private audio stream. This pairing process can often be manual, requiring repetitive user involvement, which I turn can create significant limitations in user experience and fail to meet growing demand for seamless, adaptive audio connectivity within vehicles.

Current manual pairing processes mirrors those of other Bluetooth-enabled devices, where users must select a vehicle's audio system from a list of available devices each time they want to connect. This can be disruptive and time-consuming, particularly in shared vehicle environments or when users frequently change vehicles. These inconveniences are compounded in situations where users switch seats or disconnect temporarily, and often require users to repeat the pairing process entirely. Manual reconnection is not only cumbersome but detracts from the desired seamlessness of the in-vehicle audio experience. In shared or frequently used vehicles, such as rideshares or family cars, repeated pairing requirements can create an unsatisfactory user experience that impacts passengers'overall comfort and ease of use.

Beyond the inconvenience of manual pairing, existing systems struggle to account for changes in seating arrangements. In many cases, once a user pairs their wireless device, the system cannot adapt if the user sits in a different seat during a subsequent ride. For example, where a user connects their device while sitting in the front passenger seat, existing systems will continue to route audio to that location even if the user later changes seats. This misrouting can lead to privacy issues, as audio intended for one individual may become audible to others in the vehicle. Furthermore, it presents usability concerns, as users may not be able to hear their intended audio clearly or may inadvertently disrupt other passengers. The inability to dynamically recognize and adjust to seat changes demonstrates a critical gap in current systems, limiting their adaptability and effectiveness in delivering a personalized audio experience.

The problem can be compounded where multiple passengers wish to connect their devices simultaneously. In such cases, existing systems lack the capacity to differentiate between devices or assign them accurately to specific seats, creating conflicts in audio routing. Even if multiple devices can connect, there is no assurance that the system will correctly identify and route audio to each device's intended user, especially if seats are changed or if passengers enter or exit the vehicle. The lack of a reliable system for dynamically managing these changes results in inconsistent, often frustrating experiences for passengers, particularly in shared and commercial transportation scenarios where efficiency and privacy are paramount.

Existing solutions primarily rely on basic proximity detection and manual pairing mechanisms, which are inadequate for addressing the dynamic and diverse needs of in-vehicle environments. Current systems lack the capability to automatically detect when users change seats or when new passengers enter, leading to misrouted audio and privacy issues. To create a truly adaptive in-vehicle audio experience, systems must be able to detect and respond to seat location changes, and automatically assign audio to the correct seat based on real-time user positioning.

As alluded to above, improved techniques for user identification and device pairing onboard vehicles are desirable, and various embodiments are described herein to this end and/or other ends.

According to an embodiment, a system can comprise a memory that stores computer executable components, and a processor that executes the computer executable components stored in the memory, including a passenger identification component that identifies a passenger inside the vehicle and determines in which seat the passenger is sitting. The computer executable components can further comprise a device identification component that identifies a device of the passenger and determines a pairing status of the device. The computer executable components can further comprise a pairing component that, in response to the determined pairing status, prompts the passenger to adjust the pairing status of the device.

According to another embodiment, a method can comprise identifying, by a system onboard a vehicle comprising a processor, a passenger inside the vehicle and determining, by the system, in which seat the passenger is sitting. The method can further comprise identifying, by the system, a device of the passenger and determining, by the system, a pairing status of the device. The method can further comprise, in response to the determined pairing status, prompting, by the system, the passenger to adjust the pairing status of the device.

According to yet another embodiment, a non-transitory machine-readable medium can comprise executable instructions that, when executed by a processor integrated on or within a vehicle, facilitate performance of operations, comprising, identifying a passenger inside the vehicle, determining in which seat the passenger is sitting, identifying a device of the passenger, determining a pairing status of the device, and, in response to the determined pairing status, prompting the passenger to adjust the pairing status of the device.

### BRIEF DESCRIPTION OF DRAWINGS

FIGS. 1-2 illustrate block diagrams of exemplary automated user device detection, pairing and regulation systems, in accordance with one or more embodiments described herein.

FIG. 3 illustrates example seating environments within vehicles for user device detection, pairing and regulation in accordance with one or more embodiments described herein.

FIG. 4 illustrates example seating environments within vehicles for user device detection, pairing and regulation in accordance with one or more embodiments described herein.

FIG. 5 illustrates example seating environments within vehicles for user device detection, pairing and regulation in accordance with one or more embodiments described herein.

FIG. 6 illustrates example seating environments within vehicles for user device detection, pairing and regulation in accordance with one or more embodiments described herein.

FIG. 7 illustrates example seating environments within vehicles for user device detection, pairing and regulation in accordance with one or more embodiments described herein.

FIG. 8 illustrates a flow diagram of an example, non-limiting computer implemented method that can facilitate automated detection, pairing and regulation of user devices onboard vehicles in accordance with one or more embodiments described herein.

FIG. 9 illustrates a flow diagram of an example, non-limiting computer implemented method that can facilitate automated detection, pairing and regulation of user devices onboard vehicles in accordance with one or more embodiments described herein.

FIG. 10 is an example of a non-limiting computing environment in which one or more embodiments described herein can be implemented.

FIG. 11 is an example of a non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As alluded to above, improved techniques for user identification and device pairing onboard vehicles are desirable, and various embodiments are described herein to this end and/or other ends. In accordance with one or more embodiments, the disclosed solution provides a system for vehicles that facilitates automated detection, pairing and regulation of user devices onboard vehicles. In various embodiments, the onboard computer system of the vehicle can comprise a memory that stores computer-executable components, and a processor that executes the computer executable components stored in the memory. These computer-executable components can include a passenger identification component that identifies a passenger inside the vehicle and determines in which seat the passenger is sitting. The computer executable components can further comprise a device identification component that identifies a device of the passenger and determines a pairing status of the device. The computer executable components can further comprise a pairing component that, in response to the determined pairing status, prompts the passenger to adjust the pairing status of the device.

In some embodiments, the pairing component can adjust the pairing status of the device. The pairing component can prompt the passenger to pair the device with the vehicle.

According to some embodiments, the device identification component can determine that the device is paired with the vehicle, or that the device is not paired with the vehicle. That is, the device identification component can determine a pairing status of the device.

In some embodiments, the passenger identification component can use visual sensors to identify the passenger or to determine in which seat the passenger is sitting. The passenger identification component can determine whether a passenger has entered the vehicle and in which seat the passenger is sitting. The passenger identification component can determine whether a passenger has left the vehicle and whether the seat in which the passenger was sitting is currently unoccupied. The passenger identification component can further determine whether a passenger within the vehicle has changed seats and in which seat the passenger is presently occupying.

According to some embodiments, the system can further comprise an artificial intelligence component that trains an artificial intelligence system to identify a passenger inside the vehicle. The artificial intelligence component can train the artificial intelligence system to determine in which seat the passenger is sitting. The artificial intelligence component can train the artificial intelligence system to identify a device of the passenger and determine a pairing status of the device.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments described herein.

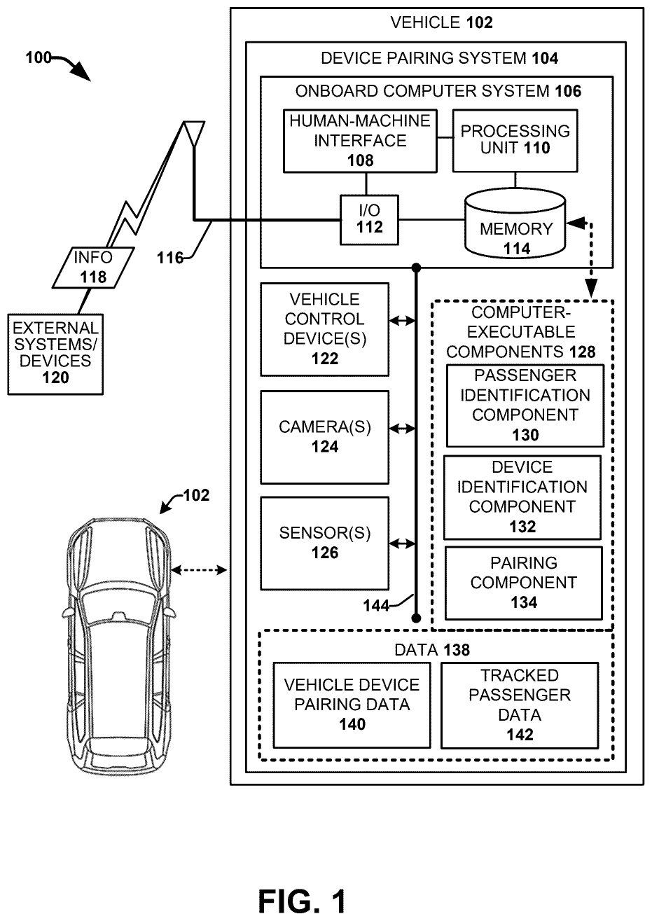

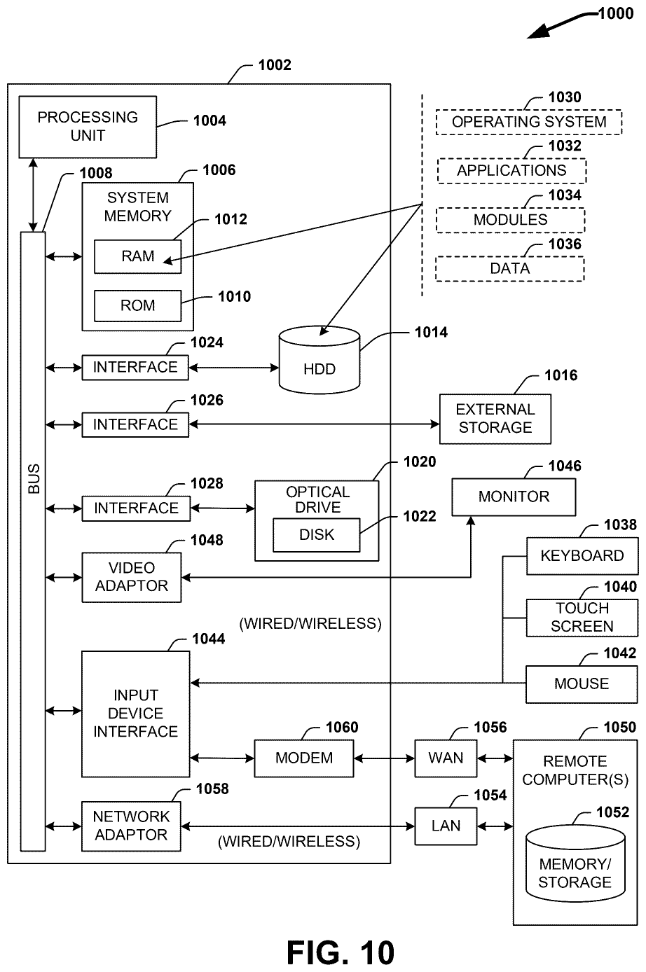

Turning now to the drawings, FIG. 1 illustrates a block diagram of an exemplary system 100 that facilitates automated detection, pairing and regulation of user devices onboard a vehicle. System 100 includes a vehicle 102 comprising a device pairing system 104 integrated thereon or therein. The device pairing system 104 includes one or more vehicle control device 122, one or more cameras 124, one or more sensors 126 and an onboard computer system 106. The onboard computer system 106 comprises at least one memory 114 that stores computer-executable components 128 and data 138 that facilitate automated detection, pairing and regulation of user devices onboard vehicle 102. These computer-executable components include (but are not limited to) passenger identification component 130, device identification component 132, and pairing component 134. The onboard computer system 106 includes at least one processor or processing unit 110 that executes the computer-executable component 128 stored in memory 114 to carry out the operations/functions described with respect to the corresponding computer-executable components. Examples of said memory 114, processing unit 110, and other computer system components that can be included in the onboard computer system 106 to facilitate the various features and functionalities of system 100 can be found with reference to FIG. 10 (e.g., system memory 1010, processing unit 1004, and the like).

The onboard computer system 106 can further include an input/output (I/O) component 112, wherein the I/O component 112 can be a transceiver configured to enable transmission/receipt of information 118 between the onboard computer system 106 and various external systems or devices 120. For example, the external systems or devices 120 can correspond to any type of device or computing system configured to wirelessly communicate (e.g., using radio frequency signals) with the onboard computer system 106, such as but not limited to, a mobile device associated with one or more users of the vehicle 102 (e.g., a smartphone, a smartwatch, a tablet, eyewear, a wearable headset or another type of wearable device), an external computer, an external computer system, an external application server, another vehicle's onboard computer system, and so on. The I/O component 112 can be communicatively coupled, via an antenna 116, to the remotely located devices and systems (e.g., external systems/devices 120). Any suitable technology can be utilized to enable the various embodiments presented herein, regarding transmission and receiving of information 118 between the onboard computer system 106 and one or more external systems/devices 120. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

The onboard computer system 106 can also include a human-machine interface 108 that provides for receiving user input in association with utilizing the various features and functionalities of the computer-executable component 134 and presenting information to users. For example, the human-machine interfaces 108 can include or correspond to any suitable output device such as a display, a speaker, etc. and any suitable input device, such as a touchscreen display, a microphone, a keypad, a keyboard, a camera, a gesture input device/system, a voice input device/system, and the like. Examples of suitable input and output devices of the human-machine interface 108 devices are further provided with reference to FIG. 10. The friction estimation system 104 also include a system bus 144 that communicatively and operatively couples the onboard computer system 106, the one or more vehicle control device 122, the one or more cameras 124 and the one or more sensors 126 to one another using any suitable wired or wireless communication technology.

Vehicle 102 can correspond to any suitable type of transportation vehicle comprising one or more windows and adapted for use in scenarios in which monitoring the external environment is important, such as varying weather conditions or navigation in complex environments. For instance, vehicle 102 can include or correspond to any suitable type of motor vehicle (e.g., a car, a truck, a van, a sport utility vehicle (SUV), etc.). In some implementations vehicle 102 can also include or correspond to an aircraft (e.g., an airplane, a helicopter, or the like), a watercraft, or another type of passenger transportation vehicle. In some embodiments, vehicle 102 can include or correspond to an autonomous vehicle that is capable of navigating and operating without (or some) human input.

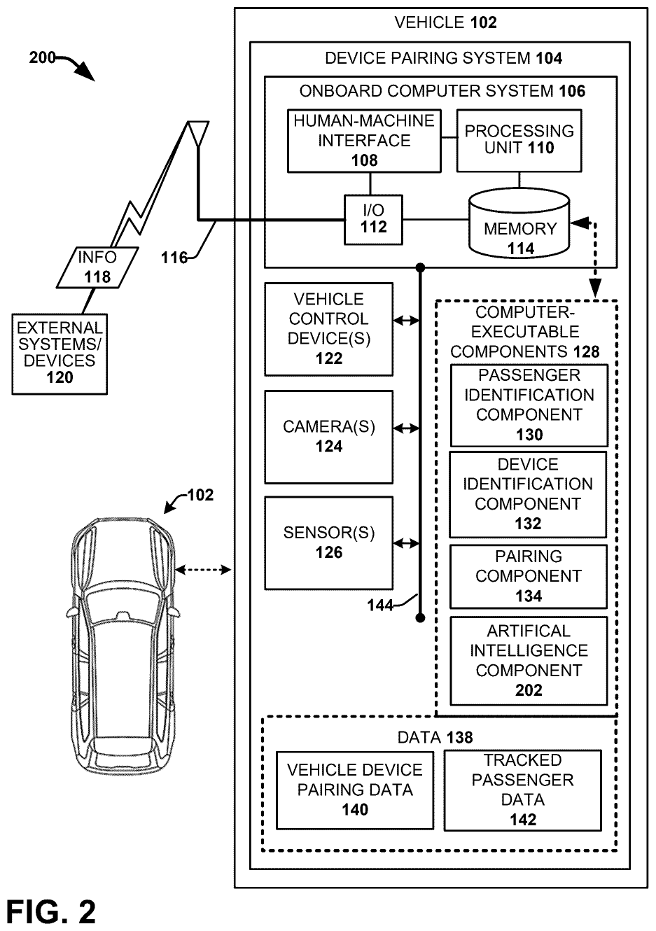

FIG. 2 illustrates an example system 200 that can facilitate automated detection, pairing and regulation of user devices onboard vehicle 102. System 200 includes a vehicle 102 comprising a device pairing system 104 integrated thereon or therein. The device pairing system 104 includes one or more vehicle control device 122, one or more cameras 124, one or more sensors 126 and an onboard computer system 106. The onboard computer system 106 comprises at least one memory 114 that stores computer-executable components 128 and data 138 that facilitate automated detection, pairing and regulation of user devices onboard vehicle 102. System 200 includes computer-executable components (but are not limited to) passenger identification component 130, device identification component 132, pairing component 134 and artificial intelligence component 202.

The passenger identification component 130 identifies a passenger inside the vehicle and determines in which seat the passenger is sitting. In some embodiments, the passenger identification component 130 can use visual sensors to identify the passenger or to determine in which seat the passenger is sitting. The passenger identification component 130 can determine whether a passenger has entered the vehicle and in which seat the passenger is sitting. The passenger identification component 130 can determine whether a passenger has left the vehicle and whether the seat in which the passenger was sitting is currently unoccupied. The passenger identification component 130 can further determine whether a passenger within the vehicle has changed seats and in which seat the passenger is presently occupying.

The device identification component 132 identifies a device of the passenger and determines a pairing status of the device. According to some embodiments, the device identification component 132 can determine that the device is paired with the vehicle, or that the device is not paired with the vehicle. The device identification component 132 can identify a device type of the identified device. The device identification component 132 can identify a make and model of the identified device. The device identification component 132 can identify that a device belongs to a particular passenger or user of the vehicle. The device identification component 132 can determine whether the identified device is being used by the particular passenger or user, by another passenger or user, by any combination of users, or that it is not being used be any users.

The pairing component 134, in response to the determined pairing status, prompts the passenger to adjust the pairing status of the device. In some embodiments, the pairing component 134 can adjust the pairing status of the device. The pairing component 134 can prompt the passenger to pair the device with the vehicle. The pairing component 134 can automatically adjust the pairing status of the device, without requiring the passenger to do anything. In some embodiments, the pairing component 134 adjusts the pairing status of the device in response to inferred passenger intent. In some embodiments, the pairing component 134 adjusts the pairing status of the device in response to a passenger entering or exiting the vehicle. In some embodiments, the pairing component 134 adjusts the pairing status of the device in response to a passenger changing seats within the vehicle. In some embodiments, the pairing component 134 adjusts the pairing status of the device in response to a different passenger using the device.

The artificial intelligence component 202 trains an artificial intelligence system to identify a passenger inside the vehicle. The artificial intelligence component 202 can train the artificial intelligence system to determine in which seat the passenger is sitting. The artificial intelligence component 202 can train the artificial intelligence system to identify a device of the passenger and determine a pairing status of the device. The artificial intelligence component 202 can train the artificial intelligence system to prompts the passenger to adjust the pairing status of the device. The artificial intelligence component 202 can train the artificial intelligence system to adjust the pairing status of the device.

The systems and/or devices are described herein with respect to interaction between one or more components. Such systems and/or components can include the components and/or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity but known by those of skill in the art.

One or more systems, devices, computer program products, and/or computer-implemented methods provided herein relate to automated detection, pairing and regulation of user devices onboard a vehicle. A system can include a processor that executes computer executable components stored in memory. The computer executable components can include a passenger identification component that identifies a passenger inside the vehicle and determines in which seat the passenger is sitting. The computer executable components can further comprise a device identification component that identifies a device of the passenger and determines a pairing status of the device. The computer executable components can further comprise a pairing component that, in response to the determined pairing status, prompts the passenger to adjust the pairing status of the device.

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 100 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 100 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 100 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

Systems herein can comprise one or more computer and/or machine readable, writable, and/or executable components and/or instructions that, when executed by processor (e.g., a processing unit 110 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processing unit 116) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 100 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

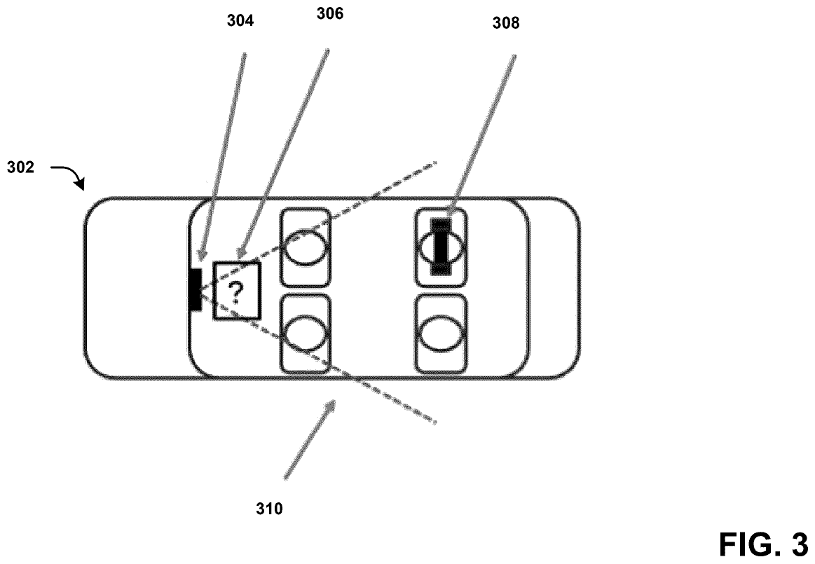

FIG. 3 illustrates example seating environments within a vehicle 302 for user device detection, pairing and regulation in accordance with one or more embodiments described herein.

In an embodiment, the AV can use eye tracking camera 304 with field of view 310 to monitor passengers within the vehicle 302. For example, a non-limiting use scenario can include using the eye tracking camera 304 to identify that there are four passengers, including a driver, currently present inside the vehicle. The AV can use the eye tracking camera 304 to determine whether any of the passengers are known users of the vehicle. For example, the AV can determine that the driver is the known owner of the vehicle, that the front seat passenger is a known passenger/user of the vehicle, and that the two rear seat passengers are unknown (or new) passengers.

The AV can determine a hierarchy of users. The hierarchy can be determined based upon usage patterns learned by the AV. Alternatively, the hierarchy can be programed or pre-programmed. For example, the AV can be programmed such that the driver of the vehicle is always the top individual in the hierarchy of passengers. Alternatively, the AV can be programmed so that a specific individual/user, when present in the vehicle, is always the top individual in the hierarchy of passengers.

In another non-limiting example, the AV can use tracking camera 304 to infer the respective ages of passengers present in the vehicle, and the hierarchy can be based at least in part on the inferred respective ages of the passengers. For example, the AV can be programmed to always rank the driver of the vehicle as the top individual in the hierarchy, but to rank the remaining passengers in the vehicle according to their respective inferred ages. Where a mother and her daughter are present in the vehicle as passengers, the AV can use tracking camera 304 to identify the mother and daughter, to infer that the mother is older than the daughter, and to rank the mother higher in the hierarchy than the daughter.

In another non-limiting example, the AV can use tracking camera 304 to identify passengers in the vehicle. The AV can recognize that one user travels in the vehicle regularly, while the other identified user(s) do not. In such a case, the AV can establish the hierarchy of passengers at least in part according to how frequently they travel within the vehicle. For example, the AV can recognize that two passengers are sitting in the rear seats of the vehicle. The AV can recognize that the passenger on the right regularly uses the vehicle, while the passenger on the left rarely uses the vehicle or is a new user/passenger. The AV can rank the passenger on the right higher in the hierarchy than the passenger on the left based upon the fact that the passenger on the right is a more frequent user of the vehicle.

The AV can use tracking camera 304 to identify devices 308 of passengers. For example, the AV can identify that a passenger in the rear right seat is wearing Bluetooth headphones. The AV can determine whether the identified device 308 is capable of being paired with the vehicle. For example, the AV can determine that the Bluetooth headphones being worn by the passenger are capable of being paired with the vehicle. The AV can use an infotainment screen 306 or similar device(s) to visually communicate a pairing status of a device 308. The AV can also issue a request to a user, prompting pairing of the device with the vehicle. For example, the AV can use infotainment screen 306 to prompt the user to pair device 308 with the vehicle. Alternatively, the AV can issue the prompt directly to the device 308. For example, where the identified device is a cellular phone or tablet capable of being paired with the vehicle, the AV can issue a prompt directly to the device. Thus, the prompt can be communicated directly to the user from the AV through the device 308. In another example, the AV can determine whether the prompt can be communicated to the device 308. The AV can recognize that a prompt can be issued via a phone or tablet, but not via headphones worn by a user. The AV can determine that the user is wearing Bluetooth headphones, and that the AV therefor cannot issue a prompt to the user directly through the Bluetooth headphones. In such a case, the AV can determine that it would be preferable to issue the prompt through screen 306 or similar device(s), and the AC can issue the prompt accordingly.

The AV can use a hierarchy of users to determine whether a device should be paired with the vehicle. For example, the AV can determine that a passenger of the vehicle is a new/unknown passenger who is using a pairable device. The AV can determine that the driver of the vehicle is the top individual in the hierarchy. Before pairing the new/unknown passenger's device, the AV can first request permission from the driver or from any other individuals present in the vehicle who are higher in the hierarchy than the new passenger. By way of example, a non-limiting use case can include a mother and daughter riding in the vehicle. The AV can identify the mother and daughter, and can determine that the mother is higher in the hierarchy than the daughter. The AV can further determine that the daughter is using a pairable device, such as a phone or tablet. Before pairing the devices, or before issuing a prompt to pair the device, the AV can first request permission from the mother. If the mother grants permission, the AV can proceed with pairing the daughter's device. Alternatively, if the mother does not grant permission, the AV can prevent the daughter's device from being paired.

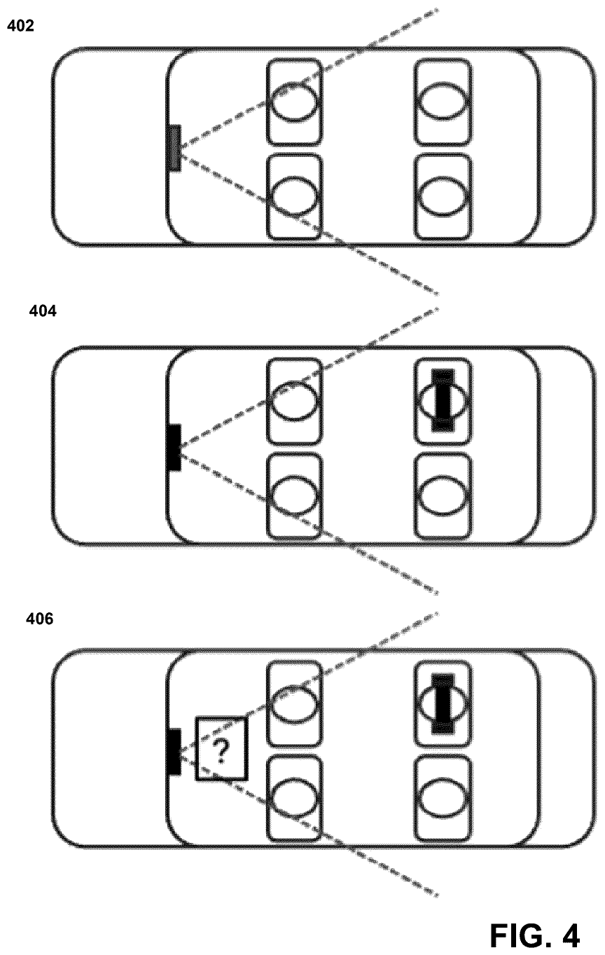

Next, FIG. 4 example seating environments within vehicles for user device detection, pairing and regulation in accordance with one or more embodiments described herein. At 402, the AV can use eye tracking camera(s) to monitor an at least one passenger within a vehicle. At 404, the AV can identify that a passenger is using a pairable wireless device, and determine a current pairing status of the device. For example, the AV can determine at 404 that the device is not currently paired with the vehicle. At 406, the AV can issue a prompt to a user (e.g., at least one of the passengers of the vehicle) asking whether the device should be paired. In response to receiving an answer, the AV can pair the device to the vehicle and can adjust parameters of the device.

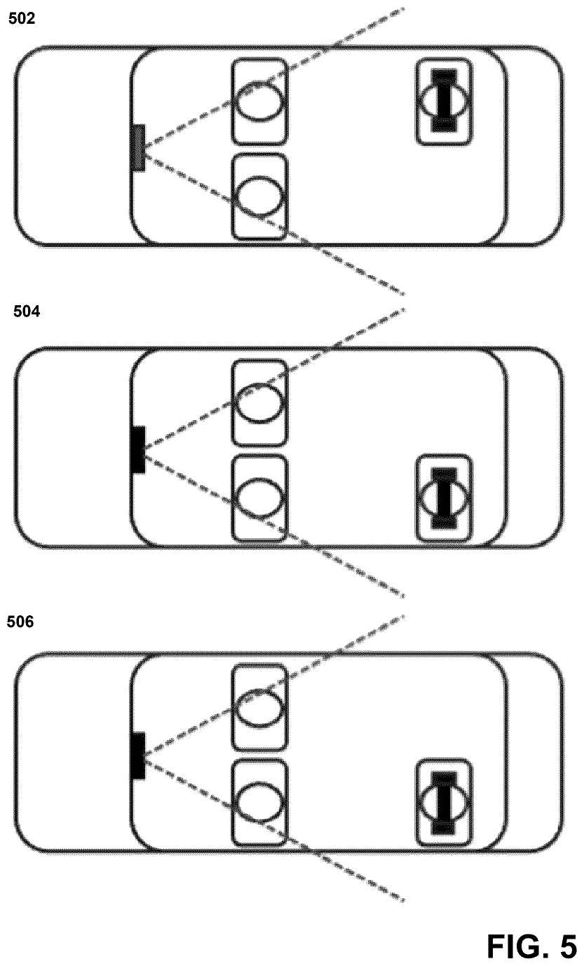

Next, FIG. 5 illustrates example seating environments within vehicles for user device detection, pairing and regulation in accordance with one or more embodiments described herein. At 502, the AV can determine that a passenger with a pairable device (e.g., headphones) is sitting in the rear right seat of the vehicle. At 504, the passenger exits the vehicle and returns to the vehicle in a new seat (e.g., the left rear seat of the vehicle). At 506, the AV can use a visual sensor (e.g., an eye-tracking camera within the vehicle) to detect that the passenger has exited the vehicle and returned to the vehicle in the new seat. The AV can update the infotainment system with information pertaining to in which seat the passenger is presently located.

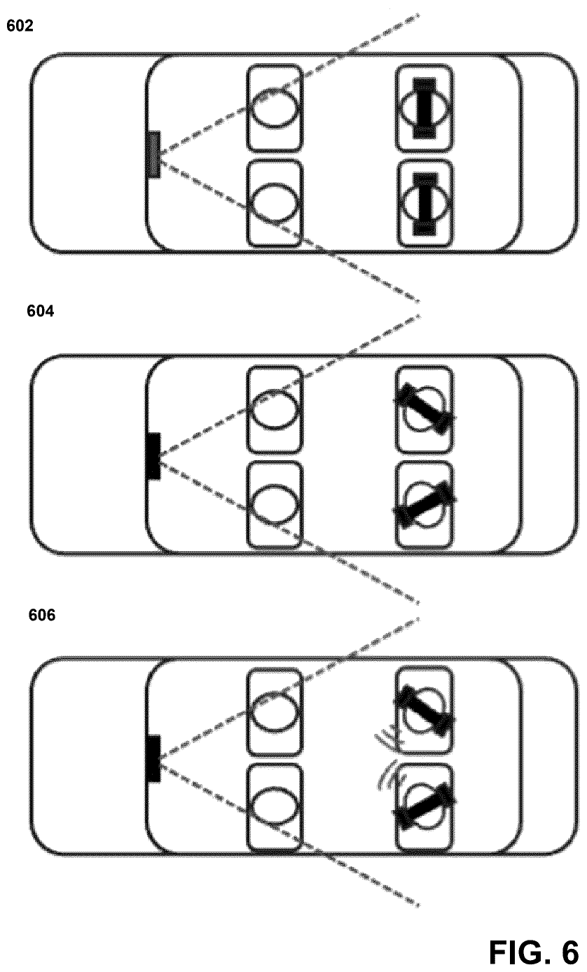

FIG. 6 illustrates example seating environments within vehicles for user device detection, pairing and regulation in accordance with one or more embodiments described herein. At 602, the AV can monitor passengers in the vehicle (e.g., using an eye-tracking camera or other visual sensor to detect passengers and determine their respective locations within the vehicle). The AV can determine that both passengers in the back seats of the vehicle are utilizing pairable devices (e.g., that both passengers are wearing headphones capable of being paired with the vehicle). At 604, the two passengers in the rear turn towards one another to speak. The AV can detect that the movement of the passengers and infer an intent of the passengers (e.g., based upon the movement of the passengers and the detected eye movements of the passengers, the AV can infer that the passengers intend to speak with one another). At 606, in response to inferring an intent of the passengers (e.g., to speak with one another), the AV can automatically adjust a setting of the device(s) such as lowering the volume to facilitate better communication between the passengers.

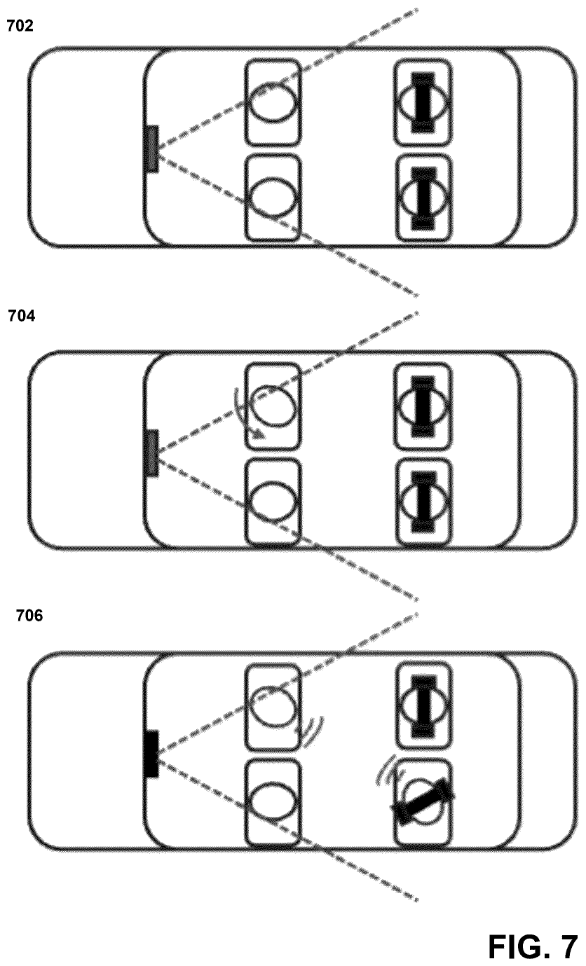

Next, FIG. 7 illustrates example seating environments within vehicles for user device detection, pairing and regulation in accordance with one or more embodiments described herein. At 702, the AV can monitor passengers in the vehicle (e.g., using an eye-tracking camera or other visual sensor to detect passengers and determine their respective locations within the vehicle). The AV can determine that both passengers in the back seats of the vehicle are utilizing pairable devices (e.g., that both passengers are wearing headphones capable of being paired with the vehicle). At 604, the left rear passenger and the right front passenger turn towards one another to speak. The AV can detect that the movement of the passengers and infer an intent of the passengers (e.g., based upon the movement of the passengers and the detected eye movements of the passengers, the AV can infer that the passengers intend to speak with one another). At 706, in response to inferring an intent of the passengers (e.g., to speak with one another), the AV can automatically adjust a setting of the device(s) such as lowering the volume of the rear left passenger to facilitate better communication between the passengers. The AV can thus ensure that only the passengers wishing to communicate with one another are impacted by the changes to device settings, while the other passengers in the vehicle are not impacted by the changes.

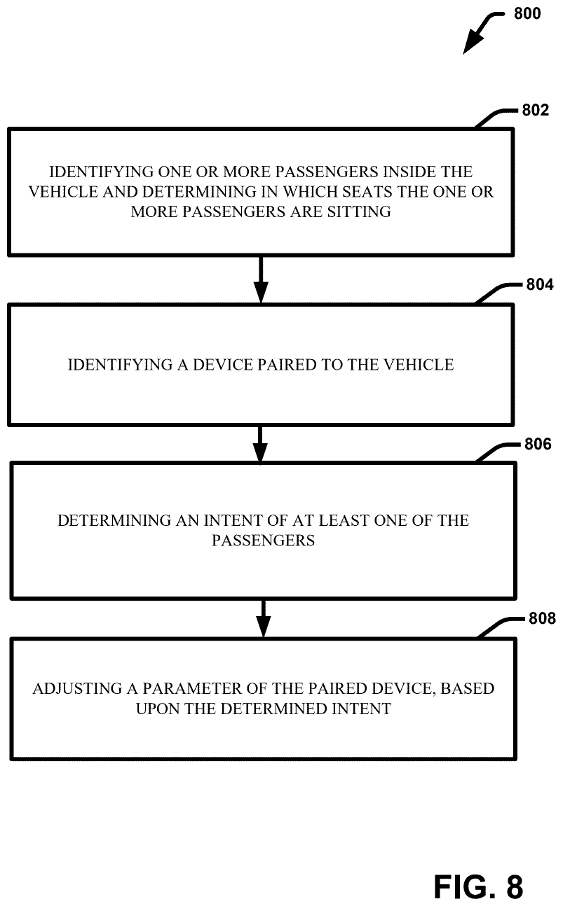

Next, FIG. 8 illustrates a flow diagram of a method 800 that can facilitate automated detection, pairing and regulation of user devices onboard a vehicle in accordance with some embodiments described herein, such as the system 200 of FIG. 2 and the system 100 of FIG. 1.

For simplicity of explanation, the computer-implemented methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

While the method 800 is described relative to the system 200 of FIG. 2, the method 800 can be applicable also to other systems described herein. Repetitive description of like elements and/or processes employed in respective embodiments is omitted for sake of brevity.

At 802, the method can include identifying one or more passengers inside the vehicle and determining in which seats the one or more passengers are sitting. At 804, the method can include identifying a device paired to the vehicle.

At 806, the method can include determining an intent of at least one of the passengers.

At 808, the method can include adjusting a parameter of the paired device, based upon the determined intent.

In some embodiments, method 800 is performed by a system, such as system 100 of FIG. 1 or system 200 of FIG. 2.

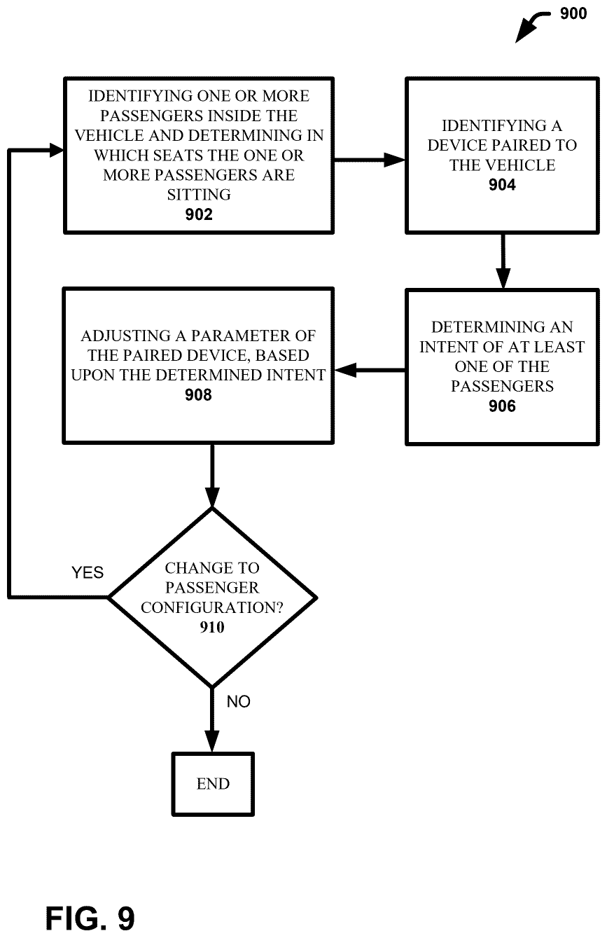

Next, FIG. 9 illustrates a flow diagram of a method 900 that can facilitate automated detection, pairing and regulation of user devices onboard a vehicle in accordance with some embodiments described herein, such as the system 200 of FIG. 2 and the system 100 of FIG. 1. While the method 900 is described relative to the system 200 of FIG. 2, the method 900 can be applicable also to other systems described herein. Repetitive description of like elements and/or processes employed in respective embodiments is omitted for sake of brevity.

At 902, the method can include identifying one or more passengers inside the vehicle and determining in which seats the one or more passengers are sitting. At 904, the method can include identifying a device paired to the vehicle.

At 906, the method can include determining an intent of at least one of the passengers.

At 908, the method can include adjusting a parameter of the paired device, based upon the determined intent.

At 910, the method can include determining whether there has been a change to the configuration of passengers within the vehicle. For example, whether a passenger has entered or existed the vehicle, or whether a passenger has changed seats within the vehicle. In response to determining that there has been no change to the configuration of passengers, the method ends. In response to determining that there has been a change to the configuration of passengers, the method can return to 902 and identify a new configuration of passengers.

In some embodiments, the method 900 can further comprise using a visual sensor to identify the one or more passengers or to determine in which seat the at least one or more passengers are sitting. In various embodiments, the method 900 can further comprise adjusting a volume setting of the paired device. In some embodiments, the method 900 can further comprise determining that a passenger has exited the vehicle, that a passenger has entered the vehicle, and/or that a passenger has changed seats. In some embodiments, the determined intent of the at least one passenger is to communicate with another passenger within the vehicle.

In some embodiments, method 900 is performed by a system, such as system 100 of FIG. 1 or system 200 of FIG. 2.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optic, infrared, and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors, field-programmable gate array, AI accelerator application-specific integrated circuit, or other suitable processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data. It is noted that unified Extensible Firmware Interface(s) can be utilized herein.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a disc 1022 such as a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the . NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

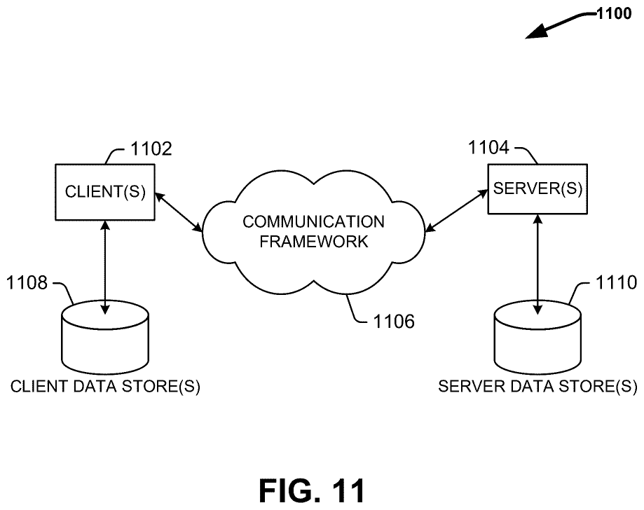

Referring now to FIG. 11, there is illustrated a schematic block diagram of a computing environment 1100 in accordance with this specification. The system 1100 includes one or more client(s) 1102, (e.g., computers, smart phones, tablets, cameras, PDA's). The client(s) 1102 can be hardware and/or software (e.g., threads, processes, computing devices). The client(s) 1102 can house cookie(s) and/or associated contextual information by employing the specification, for example.

The system 1100 also includes one or more server(s) 1104. The server(s) 1104 can also be hardware or hardware in combination with software (e.g., threads, processes, computing devices). The servers 1104 can house threads to perform transformations of media items by employing aspects of this disclosure, for example. One possible communication between a client 1102 and a server 1104 can be in the form of a data packet adapted to be transmitted between two or more computer processes wherein data packets may include coded analyzed headspaces and/or input. The data packet can include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104. Further, the client(s) 1102 can be operatively connected to one or more server data store(s) 1110.

In one exemplary implementation, a client 1102 can transfer an encoded file, (e.g., encoded media item), to server 1104. Server 1104 can store the file, decode the file, or transmit the file to another client 1102. It is noted that a client 1102 can also transfer uncompressed file to a server 1104 and server 1104 can compress the file and/or transform the file in accordance with this disclosure. Likewise, server 1104 can encode information and transmit the information via communication framework 1106 to one or more clients 1102.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:

1. A system onboard a vehicle, comprising: a memory that stores computer executable components; and a processor that executes the computer executable components stored in memory, wherein the computer executable components comprise: a passenger identification component that identifies a passenger inside the vehicle and determines in which seat the passenger is sitting; a device identification component that identifies a device of the passenger and determines a pairing status of the device; and a pairing component that, in response to the determined pairing status, prompts the passenger to adjust the pairing status of the device.

2. The system of any one or more preceding clause(s), wherein the pairing component adjusts the pairing status of the device.

3. The system of any one or more preceding clause(s), wherein the device identification component determines that the device is paired with the vehicle.

4. The system of any one or more preceding clause(s), wherein the device identification component determines that the device is not paired with the vehicle.

5. The system of any one or more preceding clause(s), wherein the pairing component prompts the passenger to pair the device with the vehicle.

6. The system of any one or more preceding clause(s), wherein the passenger identification component uses visual sensors to identify the passenger or determine in which seat the passenger is sitting.

7. The system of any one or more preceding clause(s), further comprising an artificial intelligence component that trains an artificial intelligence system to identify a passenger inside the vehicle.

8. The system of any one or more preceding clause(s), wherein the artificial intelligence component trains the artificial intelligence system to determine in which seat the passenger is sitting.

9. The system of any one or more preceding clause(s), wherein the artificial intelligence component trains the artificial intelligence system to identify a device of the passenger and determine a pairing status of the device.

10. The system of any one or more preceding clause(s), wherein the passenger identification component determines that a passenger has exited the vehicle.

11. The system of any one or more preceding clause(s), wherein the passenger identification component determines that a passenger has entered the vehicle.

12. The system of any one or more preceding clause(s), wherein the passenger identification component determines that a passenger has changed seats.

13. A computer-implemented method performed by a data processing device of a vehicle, comprising: identifying one or more passengers inside the vehicle and determining in which seats the one or more passengers are sitting; identifying a device paired to the vehicle; determining an intent of at least one of the passengers; and adjusting a parameter of the paired device, based upon the determined intent.

14. The computer-implemented method of any one or more preceding clause(s), further comprising using a visual sensor to identify the one or more passengers or to determine in which seat the at least one or more passengers are sitting.

15. The computer-implemented method of any one or more preceding clause(s), further comprising adjusting a volume setting of the paired device.

16. The computer-implemented method of any one or more preceding clause(s), further comprising determining that a passenger has exited the vehicle.

17. The computer-implemented method of any one or more preceding clause(s), further comprising determining that a passenger has entered the vehicle.

18. The computer-implemented method of any one or more preceding clause(s), further comprising determining that a passenger has changed seats.

19. The computer-implemented method of any one or more preceding clause(s), wherein the determined intent of the at least one passenger is to communicate with another passenger within the vehicle.

20. A computer program product comprising a computer readable storage medium having program instructions embodied therewith, the program instructions executable by a processor to cause the processor to: identify one or more passengers inside the vehicle and determine in which seats the one or more passengers are sitting; identify a device paired to the vehicle; determine an intent of at least one of the passengers; and adjust a parameter of the paired device, based upon the determined intent.

21. Any suitable combination of any one or more of system clauses 1-12.

22. Any suitable combination of any one or more method clauses 13-19.

23. Any suitable combination of non-transitory machine-readable storage medium clause 20.

24. Any suitable combination of any features of any one or more of clauses 1-20.

What is claimed is:

1. A system onboard a vehicle, comprising:
a memory that stores computer executable components; and
a processor that executes the computer executable components stored in memory, wherein the computer executable components comprise:
a passenger identification component that identifies a passenger inside the vehicle and determines in which seat the passenger is sitting;
a device identification component that identifies a device of the passenger and determines a pairing status of the device; and
a pairing component that, in response to the determined pairing status, prompts the passenger to adjust the pairing status of the device.

2. The system of claim 1, wherein the pairing component adjusts the pairing status of the device.

3. The system of claim 1, wherein the device identification component determines that the device is paired with the vehicle.

4. The system of claim 1, wherein the device identification component determines that the device is not paired with the vehicle.

5. The system of claim 1, wherein the pairing component prompts the passenger to pair the device with the vehicle.

6. The system of claim 1, wherein the passenger identification component uses visual sensors to identify the passenger or determine in which seat the passenger is sitting.

7. The system of claim 1, further comprising an artificial intelligence component that trains an artificial intelligence system to identify a passenger inside the vehicle.

8. The system of claim 7, wherein the artificial intelligence component trains the artificial intelligence system to determine in which seat the passenger is sitting.

9. The system of claim 8, wherein the artificial intelligence component trains the artificial intelligence system to identify a device of the passenger and determine a pairing status of the device.

10. The system of claim 1, wherein the passenger identification component determines that a passenger has exited the vehicle.

11. The system of claim 1, wherein the passenger identification component determines that a passenger has entered the vehicle.

12. The system of claim 11, wherein the passenger identification component determines that a passenger has changed seats.

13. A computer-implemented method performed by a data processing device of a vehicle,
comprising:
identifying one or more passengers inside the vehicle and determining in which seats the one or more passengers are sitting;
identifying a device paired to the vehicle;
determining an intent of at least one of the passengers; and
adjusting a parameter of the paired device, based upon the determined intent.

14. The method of claim 13, further comprising using a visual sensor to identify the one or more passengers or to determine in which seat the at least one or more passengers are sitting.

15. The method of claim 13, further comprising adjusting a volume setting of the paired device.

16. The method of claim 13, further comprising determining that a passenger has exited the vehicle.

17. The method of claim 13, further comprising determining that a passenger has entered the vehicle.

18. The method of claim 13, further comprising determining that a passenger has changed seats.

19. The method of claim 13, wherein the determined intent of the at least one passenger is to communicate with another passenger within the vehicle.

20. A non-transitory machine-readable storage medium, comprising executable instructions that, when executed by a processor onboard a vehicle, facilitate performance of operations, comprising:
identifying one or more passengers inside the vehicle and determining in which seats the one or more passengers are sitting;
identifying a device paired to the vehicle;
determining an intent of at least one of the passengers; and
adjusting a parameter of the paired device, based upon the determined intent.
